(19) United States
(12) Patent Application Publication
(10) Pub. No.: US 2015/0251345 A1
(43) Pub. Date: Sep. 10, 2015

(54) STAINLESS STEEL-RESIN COMPOSITE AND METHOD OF PREPARING THE SAME

(71) Applicant: BYD COMPANY LIMITED, Shenzhen (CN)

(72) Inventors: Xiao ZHANG, Shenzhen (CN); Yun CHENG, Shenzhen (CN); Qiang GUO, Shenzhen (CN)

(21) Appl. No.: 14/723,344

(22) Filed: May 27, 2015

Related U.S. Application Data
(63) Continuation of application No. PCT/CN2013/090471, filed on Dec. 25, 2013.

(30) Foreign Application Priority Data
Dec. 28, 2012 (CN) 201210581996.0

(51) Int. Cl. B29C 45/14; C23F 1/00; C23C 4/02; C23C 4/08

(52) U.S. Cl. CPC B29C 45/14311; C23C 4/08; C23F 1/00; C23C 4/02; B29K 2023/06; B29K 2071/00

(57) ABSTRACT

A stainless steel-resin composite and method of preparing the same are provided. The method comprises providing a stainless steel substrate, spraying aluminum particles onto a first surface of the stainless steel substrate via thermal spraying to form an aluminum layer on the first surface of the stainless steel substrate, removing the aluminum layer by immersing the stainless steel substrate into an alkaline solution with a pH value greater than or equal to 10 so as to form a porous surface, and injecting a resin composition onto the porous surface of the stainless steel substrate so as to form a resin layer.

### CROSS-REFERENCE TO RELATED APPLICATIONS

This application is a Continuation of International Application No. PCT/CN2013/090471, filed on Dec. 25, 2013, which claims priority to and the benefit of Chinese Patent Application Serial No. 201210581996.0, filed with the State Intellectual Property Office of P. R. China on Dec. 28, 2012. The contents of the above-referenced applications are incorporated herein by reference in their entirety.

### FIELD

The present disclosure relates to a stainless steel-resin composite and method of preparing the same.

### BACKGROUND

The statements in this section merely provide background information related to the present disclosure and may not constitute prior art.

In fields of vehicles, household electrical appliances, industrial machines and so on, there is an actual requirement for integrating a metal with a resin composition. Currently, the metal and resin composition are normally integrated by an adhesion agent at room temperature or with heat treatment. However, metal-resin composites formed with the adhesion agent may have a poor adhesion between the metal and the resin composition. In addition, a subsequent surface treatment such as anodic oxidation may not be able to be carried out, because the adhesion agent between the metal and the resin composition has poor acid resistance and alkali resistance.

Currently, a stainless steel-resin composite may be formed by steps of: corroding a stainless steel substrate with an acid etching solution so as to form an ultra micro concave-convex structure in the surface of the stainless steel substrate; and injecting a resin composition to the surface of the stainless steel substrate to combine the stainless steel substrate with the resin composition. Due to seriously corrosion of the acid etching solution to the stainless steel substrate, the thickness of the stainless steel substrate may be thinned, which may influence the structure stability of the stainless steel-resin composite. Moreover, the acid etching solution may also corrode a non-injected area of the stainless steel substrate (surface of the stainless steel substrate which does not need to be injected with the resin composition), especially, an area which will be part of an appearance surface of the stainless steel-resin composite. Therefore, these areas may need to be subsequently treated with polishing or computer numerical control (CNC) machining or other subsequent treatment. Thus, the process for manufacturing a stainless steel-resin composite may become complicated, which may be a barrier for widely using the stainless steel-resin composite. Especially, the adhesive force between the between the stainless steel and the resin is not high enough and should be improved.

### SUMMARY

The present disclosure seeks to solve at least one of the problems existing in the prior art to at least some extent.

A first aspect of the present disclosure provides a method of preparing a stainless steel-resin composite. The method may comprise providing a stainless steel substrate, spraying aluminum particles onto a first surface of the stainless steel substrate via thermal spraying to form an aluminum layer on the first surface of the stainless steel substrate, removing the aluminum layer by immersing the stainless steel substrate in an alkaline solution with a pH value greater than or equal to 10 so as to form a porous surface, and injecting a resin composition onto the porous surface of the stainless steel substrate to form a resin layer.

A second aspect of the present disclosure provides a stainless steel-resin composite. The stainless steel-resin composite may be prepared by the method mentioned above and comprise: a stainless steel substrate having a porous surface, and a resin layer disposed on the porous surface of the stainless steel substrate.

With the method of preparing the stainless steel-resin composite according to embodiments of the present disclosure, some aluminum particles may be implanted in the surface layer of the stainless steel substrate due to high temperature and high speed thermal spraying. After the stainless steel substrate is immersed into the alkaline solution, the aluminum particles may be removed and a plurality of unique and irregular eroded pores may be left, and a porous surface may be formed. The plurality of eroded pores in the porous surface may have irregular and unique structures, which may help improve the adhesive strength between the stainless steel and the resin, and injection molding of the resin composition may become easier without any particular requirements of the resin compositions, which may broaden the application of the method according to embodiments of the present disclosure.

In addition, the aluminum particles may be selectively sprayed onto a special area of the surface of the stainless steel substrate. That is, the aluminum particles may be only sprayed onto a first part of the surface that needs to be injected with the resin composition. For example, a second part (e.g., a left part) of the surface of the stainless steel substrate, which does not need to be injected with the resin composition, may be covered by a mold, thus, the second part of the surface may not be implanted with the aluminum particles. Moreover, the alkaline solution having a pH greater than or equal to 10 may not corrode the second part of the surface, therefore the appearance of the second part of the surface and the dimension of the stainless steel substrate may not be affected. Furthermore, heat released during the production process is low which may not influence the appearance of the stainless steel substrate. There is no pollution to the environment, and the process is simple, thus the method of preparing a stainless steel-resin composite according to the present disclosure may be suitable for mass production.

Additional aspects and advantages of embodiments of present disclosure will be given in part in the following descriptions, become apparent in part from the following descriptions, or be learned from the practice of the embodiments of the present disclosure.

### DETAILED DESCRIPTION

Reference will be made in detail to embodiments of the present disclosure; samples of described embodiments are indicated in the drawings. The embodiments described herein with reference to drawings are explanatory, illustrative, and used to generally understand the present disclosure. The embodiments shall not be construed to limit the present disclosure.

According to a first aspect of the present disclosure, a method for preparing a stainless steel-resin composite is provided. The method may include providing a stainless steel substrate, spraying aluminum particles onto a first surface of the stainless steel substrate by thermal spraying to form an aluminum layer on the first surface of the stainless steel substrate, removing the aluminum layer by immersing the stainless steel substrate in an alkaline solution with a pH value greater than or equal to 10 to form a porous surface, and injecting a resin composition onto the porous surface of the stainless steel substrate to form a resin layer.

In some embodiments, the spraying step may be performed on a partial surface of the stainless steel substrate, such as, a part of the surface which needs to be injected with the resin composition. In one embodiment, the thermal spraying step may include spraying aluminum particles on a first part of the surface of the stainless steel substrate. Therefore, a second part of the surface of the stainless steel substrate may not be impacted, and the second part of the surface does not need to be subsequently treated with polishing or CNC machining or other processing. In this embodiment, the second part of the surface of the stainless steel substrate, which may not need to be injected with the resin composition, may be covered by a mold. For example, the stainless steel substrate can be placed into a designed mold which can cover the second part of the surface of the stainless steel substrate, then the mold may be placed in a thermal spraying equipment for thermal spraying, therefore the aluminum particles can only be sprayed onto the first part of the surface of the stainless steel substrate.

In some embodiments, a particle feed rate of the thermal spraying is about 30 g/minute to about 100 g/minute, preferably about 60 g/minute to about 80 g/minute.

In some embodiments, a spraying distance (the distance between the source of the thermal spraying and the surface of the stainless steel substrate) of the thermal spraying is about 300 millimeters to about 420 millimeters, preferably about 340 millimeters to about 390 millimeters.

In some embodiments, a temperature of the thermal spraying is about 2000 Celsius degrees to about 5000 Celsius degrees, preferably about 2600 Celsius degrees to about 3000 Celsius degrees. The temperature could be controlled by regulating a flow rate of kerosene and oxygen. By adjusting the temperature in the above scope, more aluminum particles may be implanted deep into the surface layer of stainless steel substrate form a better surface structure that may improve the adhesive force between the stainless steel substrate and the resin composition.

There are no particular limitations for the thermal spraying. In some embodiments, the thermal spraying comprises at least one selected from arc spraying, plasma spraying or hypersonic flame spraying. Considering that the equipment and operation technique are well known by those skill in the art, the details for these thermal spraying methods are omitted herein.

In one embodiment, the aluminum layer on the stainless steel substrate has a thickness of about 100 microns to about 400 microns. In another embodiment, the aluminum layer adhered on the stainless steel substrate has a thickness of about 150 microns to about 200 microns. A thiner layer may not only decrease consumption of the raw material and cost, but also benefit the subsequent treatment and further optimize the performance of the stainless steel-resin composite.

In some embodiments, the aluminum particles have an average diameter of about 30 microns to about 50 microns, and a purity of greater than 99 wt %. The aluminum particles are commercially available.

In some embodiments of the present disclosure, the stainless steel substrate is allowed to cool-down to room temperature after the spraying step. For example, the stainless steel substrate may be taken out of the spraying equipment and rested at room temperature for 0.5 hours to 12 hours for cooling-down.

In some embodiments of the present disclosure, after the spraying step, some aluminum particles may be implanted into the surface layer of the stainless steel substrate, and some aluminum particles may be disposed on the aluminum particles that implanted into the surface layer of the stainless steel substrate.

In some embodiments, an alkaline solution with a pH greater than 12 and less than 14 is prepared. The stainless steel substrate is immersed in the alkaline solution, the aluminum layer may be removed, and a porous surface having a plurality of eroded pores are formed.

In some embodiments, the alkaline solution comprises at least one selected from soluble carbonate solution, soluble alkali solution, soluble phosphate solution, soluble sulphate solution or soluble borate solution. For example, the alkaline solution comprises at least one selected from Na₂CO₃ solution, NaHCO₃ solution, NaOH solution, Na₂HPO₄ solution, Na₃PO₄ solution, KOH solution, KHCO₃ solution, K₂CO₃ solution, Na₂SO₃ and K₃PO₄ solution. In some embodiments, the Na₂CO₃ solution has a mass concentration of about 5 wt % to about 20 wt %, the NaHCO₃ solution has a mass concentration of about 5 wt % to about 20 wt %, the NaOH solution has a mass concentration of about 5 wt % to about 20 wt %, the Na₂HPO₄ solution has a mass concentration of about 5 wt % to about 20 wt %, the Na₃PO₄ solution has a mass concentration of about 5 wt % to about 20 wt %, the KOH solution has a mass concentration of about 5 wt % to about 20 wt %, the KHCO₃ solution has a mass concentration of about 5 wt % to about 20 wt %, the K₂CO₃ solution has a mass concentration of about 5 wt % to about 20 wt %, the Na₂SO₃ has a mass concentration of about 5 wt % to about 20 wt %₃ and the K₃PO₄ solution has a mass concentration of about 5 wt % to about 20 wt %. In some embodiments, the alkaline solution comprises at least one selected from NaOH solution having a mass concentration of about 5 wt % to about 20 wt %, KOH solution having a mass concentration of about 5 wt % to about 20 wt %, Na₂CO₃ solution having a mass concentration of about 5 wt % to about 20 wt %, and K₃PO₄ solution having a mass concentration of about 5 wt % to about 20 wt %. In some other embodiments, the alkaline solution is at least one selected from a group consisting of NaOH solution having a mass concentration of about 5 wt % to about 15 wt %, KOH solution having a mass concentration of about 5 wt % to about 15 wt %, Na₂CO₃ solution having a mass concentration of about 5 wt % to about 15 wt %, and K₃PO₄ solution having a mass concentration of about 5 wt % to about 15 wt %. The aluminum layer may be removed quickly, and the stainless steel substrate may not be affected by the alkaline solution, and the eroded pores formed on the surface of the stainless steel may have an excellent pore structure which may further optimize the binding property between the resin composition and stainless steel substrate. The stainless steel-resin composite obtained may have a better tensile strength and the integration combination between stainless steel and resin composition is better.

In one embodiment, the stainless steel substrate is immersed into the alkaline solution under a temperature of about 10 Celsius degrees to about 80 Celsius degrees, preferably about 30 Celsius degrees to about 70 Celsius degrees, for about 10 minutes to about 120 minutes, preferably for about 10 minutes to about 60 minutes.

In some embodiments, the stainless steel substrate is immersed into the alkaline solution for more than one time, and the method further comprises washing the stainless steel substrate with deionized water after each immersion. In one embodiment, the stainless steel substrate is immersed for 2 times to 5 times.

In some embodiments of the present disclosure, the plurality of eroded pores are irregular eroded pores. Those pores have a unique structure which may improve the adhesion force between the stainless steel substrate and the resin composition that injected into these pores.

Specifically, the injecting step may be carried out by putting the stainless steel substrate having a porous surface into a mold, and injecting a resin composition onto the porous surface and integrating the resin composition with the stainless steel substrate to obtain the stainless steel-resin composite.

Those with ordinary skill in the art will appreciate that, injecting a resin composition onto the porous surface of the stainless steel substrate to form the stainless steel-resin composite is only one particular embodiment of the present disclosure, and any other integration method may be applied to form the stainless steel-resin composite without departing from the scope of the disclosure.

In some embodiments, the step of injecting a resin composition onto the porous surface is carried out under the following condition: a nozzle temperature of about 200 Celsius degrees to about 350 Celsius degrees; mold temperature of about 50 Celsius degrees to about 200 Celsius degrees. In some embodiments, a weight of the resin composition injected is about 0.1 gram to about 1000 gram. After the step of injecting, a resin layer may be formed on the surface of the stainless steel substrate, the resin layer may have a thickness of about 0.1 millimeters to about 10 millimeters.

In some embodiments, the method further comprises a step of pretreating the first surface of the stainless steel substrate before spraying aluminum particles thereon. The pretreating method may be any commonly-used pretreating process known to person skilled in the art, which generally includes steps of: polishing the metal substrate to remove obvious foreign matters on the surface of the stainless steel substrate, and then removing the oil adhered on the surface of the stainless steel substrate and cleaning the stainless steel substrate. In one embodiment, the pretreating method comprises: polishing, for example, polishing the surface of the stainless steel substrate with a 100-400 mesh sand paper or a polishing machine to form pores with micron scale on the surface of the stainless steel substrate; removing oil, first water-washing, abrasive-blasting, second water-washing, and drying at a temperature of about 60 Celsius degrees to about 80 Celsius degrees. The oil may be removed by using different kinds of common solvent, such as ethyl alcohol or acetone, and then washing the stainless steel substrate for about 0.5 hours to about 2 hours. In one embodiment, after the oil has been removed by using absolute ethyl alcohol and washed with water, the stainless steel substrate is abrasive-blasted, which may increase the erosion depth of the aluminum particles during the thermal spraying step, and then washed with deionized water and dried at a temperature of 60 Celsius degrees to about 80 Celsius degrees.

There are no particular limitations for the stainless steel substrate, and it could be any commonly-used stainless steel substrate which is commercially available. Also, there are no particular limitations for shape and structure of the stainless steel substrate, and the shape and structure of the stainless steel substrate could be obtained through mechanical treatment.

According to some embodiments of the present disclosure, there are no particular limitations for the resin composition. The resin composition can be any resin composition which can be combined with a stainless steel substrate to form a stainless steel-resin composite.

In one embodiment, the resin composition includes a thermoplastic resin.

In some embodiments, the thermoplastic resin comprises a matrix resin and a polyolefin resin. In some embodiments, the matrix resin is a non-crystalline resin. By using the non-crystalline resin as the matrix resin, which surface gloss and toughness may be higher than the high crystalline resins in the prior art, associated with the polyolefin resin having a melting point of about 65 Celsius degrees to about 105 Celsius degrees, it is not required for the injecting process to be carried out with a specified mold temperature, thus the injecting process is simplified, and the stainless steel-resin composite obtained may have a better mechanical strength and surface characteristics that may solve the problems in surface decorating for satisfying a variety of demands from consumers.

Further, by using the resin composition of the non-crystallize resin (matrix resin) associated with the polyolefin resin having a melting point of about 65 Celsius degrees to about 105 Celsius degrees, it facilitates the resin composition to flow into nano-scale pores (the eroded pores), thus the stainless steel-resin composite obtained may have an excellent adhesion force and mechanical strength between the resin layer and the stainless steel substrate.

In one embodiment of the present disclosure, based on 100 weight parts of the thermoplastic resin, the thermoplastic resin comprises about 70 weight parts to about 95 weight parts of the matrix resin and about 5 weight parts to about 30 weight parts of the polyolefin resin.

In some embodiments, the thermoplastic resin may comprise fluidity modifier, preferably, a ring polyester. By using the fluidity modifier, the fluidity of the thermoplastic resin may be improved so as to facilitate the following injection molding step, thus the adhesion force between the resin composition and the stainless steel substrate may be improved accordingly. Preferably, based on 100 weight parts of the thermoplastic resin, the thermoplastic resin comprises about 1 weight part to about 5 weight parts of the fluidity modifier.

In some embodiments of the present disclosure, the matrix resin is a non-crystalline resin. In some embodiments, the matrix resin includes a mixture of polyphenylene oxide (PPO) and polyphenylene sulfide (PPS). In one embodiment, a weight ratio of the PPO to the PPS is 3:1 to 1:3, preferably 2:1 to 1:1.

In some embodiments, the matrix resin includes a mixture of PPO and polyamide (PA). In one embodiment, a weight ratio of the PPO to the PA is 3:1 to 1:3, preferably 2:1 to 1:1.

In some embodiments, the matrix resin includes a polycarbonate. There are no particular limitations for the polycarbonate. For example, the polycarbonate could be various kinds of straight chain polycarbonate.

According to some embodiments of the present disclosure, the polyolefin resin has a melting point of about 65 Celsius degrees to about 105 Celsius degrees. In one embodiment, the polyolefin resin includes a grafted polyethylene. In another embodiment, the grafted polyethylene has a melting point of about 100 Celsius degrees or about 105 Celsius degrees.

According to some embodiments of the present disclosure, the resin composition may comprise other additives. The additives may be selected depending on practical requirements, without particular limitations. For example, in one embodiment, in order to endue the resin composition with a required linear expansion coefficient, the resin composition further comprises a filler. The filler can be any common filler known to a person skilled in the art, such as a fiber filler or an inorganic particle filler. In some embodiments, the fiber filler comprises at least one selected from glass fiber, carbon fiber and aromatic polyamide fiber, and the inorganic particle filler comprises at least one selected from a group consisting of silicon dioxide, talcum particles, aluminum hydroxide, magnesium hydroxide, calcium carbonate, magnesium carbonate, heavy barium sulfate, glass and kaolin. In some embodiments, in order to endue the resin composition with a linear expansion coefficient in the lateral and longitudinal direction similar to that of the stainless steel substrate, the matrix resin may comprise about 50 weight parts to about 150 weight parts of the fiber filler, and about 50 weight parts to about 150 weight parts of the inorganic particle filler, based on 100 weight parts of the matrix resin.

According to some embodiments of the method of preparing the stainless steel-resin composite of present disclosure, the resin composition is formed by mixing or blending the matrix resin and the polyolefin resin. The mixing or blending method of forming the resin composition may be a common method known to a person skilled in the art. For example, the matrix resin and the polyolefin resin are mixed uniformly and then extruded by a double-screw extruder to form the resin composition.

With the method of preparing the stainless steel-resin composite according to embodiments of present disclosure, the production process is simplified, and the production time for the stainless steel-resin composite is shortened, when compared with the prior art. In addition, the stainless steel-resin composite according to embodiments of the present disclosure may have a better adhesion force between the resin composition and the stainless steel substrate, and a better tensile shear strength when compared with the prior art.

According to a second aspect of the present disclosure, a stainless steel-resin composite prepared by the above-described method is provided. The stainless steel-resin composite comprises a stainless steel substrate having a porous surface, and a resin layer disposed on the porous surface of the stainless steel substrate. The resin layer comprises a resin composition, and there are no particular limitations for the resin composition; the resin composition can be any resin composition which can form a stainless steel-resin composite with a stainless steel substrate.

The stainless steel-resin composite according to embodiments of the present disclosure may be used directly, or may be subjected to some subsequent treatments, such as CNC machining or spraying so as to use in other applications according to practical requirements.

The disclosure will be further described below by way of examples.

### Example 1

### 1) Pretreatment

A stainless steel plate (series 304) having a thickness of 1 mm was cut into 15 mm*80 mm rectangular pieces. Then these pieces of stainless steel plate were polished with a polishing machine. After being polished, these pieces of stainless steel plate were washed with absolute ethyl alcohol. Then, these pieces were abrasive-blasted, and then washed with deionized water and dried at 80 Celsius degrees.

### 2) Surface Treatment

After that, in order to cover the non-injected area, these pieces of stainless steel plate were placed in a mold, and a 15 mm*5 mm area on one end of the stainless steel plate is uncovered by the mold. Then the mold was placed in a supersonic spraying machine to thermal spray aluminum particles having a purity of 99.5 wt % and an average diameter of 30 microns on the uncovered surface of the stainless steel substrate, with a kerosene flow rate of 22 L/h, an oxygen flow rate of 930 L/minute, a particle feed rate of 75 g/minute, and a spraying distance of 370 millimeters. An aluminum layer formed on the uncovered surface of the stainless steel plate has a thickness of 100 microns. Then these pieces of stainless steel plate were taken out of the supersonic spraying machine and rested at room temperature for 2 hours for completely cooling-down. And then these pieces of stainless steel plate were immersed into a 20 wt % NaOH solution at 30 Celsius degrees for 1 hour until the aluminum particles adhered on the stainless steel plate were fully dissolved, leaving a porous surface. Then these pieces of stainless steel plate were taken out to be washed with water and dried at 80 Celsius degrees.

### 3) Molding

These dried pieces of stainless steel plate were inserted into injection molding molds respectively, and then PPS rein composition (comprising 20 wt % of glass fiber) was injected onto the porous surface of the stainless steel plate. After these pieces of stainless steel plate being removed from the molds, and cooled down, stainless steel-resin composite S1 was obtained.

### Example 2

The method for preparing a stainless steel-resin composite of Example 2 comprises substantially the same steps as Example 1 except the following differences: in the step 2), the aluminum particles had an average diameter of 50 microns. A stainless steel-resin composite S2 was obtained.

### Example 3

The method for preparing a stainless steel-resin composite of Example 3 comprises substantially the same steps as Example 1 except the following differences: in the step 2), the aluminum layer formed on the surface the stainless steel plate had a thickness of 200 microns. A stainless steel-resin composite S3 was obtained.

### Example 4

The method for preparing a stainless steel-resin composite of Example 4 comprises substantially the same steps as Example 1 with the following differences: in the step 2), the particle feed rate was 100 g/minute. A stainless steel-resin composite S4 was obtained.

### Example 5

The method for preparing a stainless steel-resin composite of Example 5 comprises substantially the same steps as Example 1 except the following differences: in the step 2), the spraying distance was 320 millimeters. A stainless steel-resin composite S5 was obtained.

### Comparative Example 1

### 1) Pretreatment

A stainless steel plate (series 304) having a thickness of 1 mm was cut into 15 mm*80 mm rectangular pieces. Then these pieces of stainless steel plate were polished with a polishing machine. After being polished, these pieces of stainless steel plate were washed with absolute ethyl alcohol. Then, these pieces were abrasive-blasted, and then washed with deionized water and dried at 80 Celsius degrees.

### 2) Surface Treatment

After that, these pieces of stainless steel plate were placed in a 20 wt % NaOH solution at 30 Celsius degrees for 1 hour. Then these pieces of stainless steel plate were taken out of the NaOH solution, and washed with water and dried at 80 Celsius degrees.

### 3) Molding

These pieces of stainless steel plate were inserted into injection molding mould, and then these pieces of stainless steel plate were inject-molded with a PPS rein composition (comprising 20 wt % of glass fiber). Then these pieces of stainless steel plate were removed from the molds, and cooled and a stainless steel-resin composite DS1 was obtained.

### Comparative Example 2

### 1) Pretreatment

A stainless steel plate (series 304) having a thickness of 1 mm was cut into 15 mm*80 mm rectangular pieces. Then these pieces of stainless steel plate were polished with a polishing machine. After being polished, these pieces of stainless steel plate were washed with absolute ethyl alcohol. Then, these pieces were abrasive-blasted, and then washed with deionized water and dried at 80 Celsius degrees.

### 2) Surface treatment

After the step 1), these pieces of stainless steel plate were placed in a 10 wt % H₂SO₄ solution at 70 Celsius degrees for 1 hour, then taken out of the H₂SO₄ solution, and washed with water and dried at 80 Celsius degrees.

### 3) Molding

These pieces of stainless steel plate after the step 2) were inserted into injection molding mold, and then these pieces of stainless steel plate were inject-molded with a PPS rein composition (comprising 20 wt % of glass fiber). Then these pieces of stainless steel plate were removed from the molds, and cooled, and a stainless steel-resin composite DS2 was obtained.

### Performance Test

### 1) Adhesion Force

These stainless steel-resin composite S1-S5 and DS1, DS2 were fixed on a universal material testing machine to perform tensile test. The shear fracture force of the test results were considered as an adhesion force between the stainless steel plate and the resin. The test results were shown in Table 1.

### 2) Appearance of Non-Injected Area

### Surface of the Stainless Steel Substrate which does not Need to be to be Injected with the Resin Composition

These stainless steel-resin composite S1-S5 and DS1, DS2 were observed under a standard light condition D65, comparing with an untreated stainless steel plate S0. The distance between samples and eyes was 30 centimeters. The observed results were recorded in Table 1.

TABLE 1

| | Shear fracture force/MPa | Appearance of non-injected area |
|---|---|---|
| S1 | 10.12 | No obvious change |
| S2 | 8.84 | No obvious change |
| S3 | 9.28 | No obvious change |
| S4 | 8.556 | No obvious change |
| S5 | 8 | No obvious change |
| DS1 | fall off after injecting | No obvious change |
| DS2 | 8.41 | Obvious corrosion, coarse and shineless |

With the stainless steel-resin composite according to the present disclosure, the stainless steel-resin composite had a good adhesion between the stainless steel and the resin. And there were no particular requirements the resin composition, thus the stainless steel-resin composite may have wider applications.

In addition, the aluminum particles may be selectively sprayed onto the special area of the surface of the stainless steel substrate, that is, the aluminum particles may be only sprayed on an the first part of the surface that to be boned with resin composition, while the second part of the surface may be covered with a mold. Thus, the second part surface may be prevented from being implanted with the aluminum particles. Moreover, the alkaline solution may not corrode the second part of the surface; therefore the appearance of the second part of the surface and the dimension of the stainless steel substrate may not be affected. Furthermore, heat released during the production process is low, which may not influence the appearance of the stainless steel substrate. And also, there is no pollution to the environment, and the process is simple, thus the method of preparing a stainless steel-resin composite according to the present disclosure may be suitable for mass production.

Although explanatory Examples have been shown and described, it would be appreciated by those skilled in the art that the above Examples can not be construed to limit the present disclosure, and changes, alternatives, and modifications can be made in the Examples without departing from spirit, principles and scope of the present disclosure.

What is claimed is:

1. A method of preparing a stainless steel-resin composite, comprising:
providing a stainless steel substrate;
spraying aluminum particles onto a first surface of the stainless steel substrate via thermal spraying to form an aluminum layer on the first surface of the stainless steel substrate;
removing the aluminum layer by immersing the stainless steel substrate into an alkaline solution with a pH value greater than or equal to 10 to form a porous surface; and
injecting a resin composition onto the porous surface of the stainless steel substrate to form a resin layer.

2. The method according to claim 1, wherein a particle feed rate of the thermal spraying is about 30 g/minute to about 100 g/minute, and a spraying distance of the thermal spraying is about 300 mm to about 420 mm.

3. The method according to claim 1, wherein the thermal spraying comprises at least one selected from arc spraying, plasma spraying and hypersonic flame spraying.

4. The method according to claim 1, wherein the aluminum layer has a thickness of about 100 microns to about 400 microns.

5. The method according to claim 1, wherein the aluminum particles have an average diameter of about 30 microns to about 50 microns, and a purity of greater than 99 wt %.

6. The method according to claim 1, wherein the alkaline solution comprises at least one selected from a group consisting of Na₂CO₃ solution, NaHCO₃ solution, NaOH solution, Na₂HPO₄ solution, Na₃PO₄ solution, KOH solution, KHCO₃ solution, K₂CO₃ solution, Na₂SO₃ and K₃PO₄ solution.

7. The method according to claim 5, wherein the Na₂CO₃ solution has a mass concentration of about 5 wt % to about 20 wt %, the NaHCO₃ solution has a mass concentration of about 5 wt % to about 20 wt %, the NaOH solution has a mass concentration of about 5 wt % to about 20 wt %, the Na₂HPO₄ solution has a mass concentration of about 5 wt % to about 20 wt %, the Na₃PO₄ solution has a mass concentration of about 5 wt % to about 20 wt %, the KOH solution has a mass concentration of about 5 wt % to about 20 wt %, the KHCO₃ solution has a mass concentration of about 5 wt % to about 20 wt %, the K₂CO₃ solution has a mass concentration of about 5 wt % to about 20 wt %, and the Na₂SO₃ has a mass concentration of about 5 wt % to about 20 wt %₃ and the K₃PO₄ solution has a mass concentration of about 5 wt % to about 20 wt %.

8. The method according to claim 1, wherein the stainless steel substrate is immersed into the alkaline solution under a temperature of about 10 Celsius degrees to about 80 Celsius degrees for about 10 minutes to about 120 minutes.

9. The method according to claim 1, wherein the pores in the porous surface are irregular eroded pores.

10. The method according to claim 1, further comprising:
pretreating the first surface of the stainless steel substrate via polishing, removing oil, first water-washing, abrasive-blasting, second water-washing, and drying at a temperature of about 60 Celsius degrees to about 80 Celsius degrees prior to the spraying step.

11. The method according to claim 1, wherein the resin composition includes a thermoplastic resin composition.

12. The method according to claim 11, wherein the thermoplastic resin composition comprises a matrix resin and a polyolefin resin.

13. The method according to claim 12, wherein the matrix resin includes a mixture of polyphenyl ether and polyphenylene sulfide.

14. The method according to claim 12 wherein the matrix resin includes a mixture of polyphenyl ether and polyamide.

15. The method according to claim 12, wherein the matrix resin includes a polycarbonate.

16. The method according to claim 12, wherein based on 100 weight parts of the thermoplastic resin, the thermoplastic resin comprises about 70 weight parts to about 95 weight parts of the matrix resin and about 5 weight parts to about 30 weight parts of the polyolefin resin.

17. The method according to claim 12, wherein the polyolefin resin has a melting point of about 65 Celsius degrees to about 105 Celsius degrees.

18. The method according to claim 17, wherein the polyolefin resin includes a grafted polyethylene.

19. The method according to claim 11, wherein, based on 100 weight parts of the thermoplastic resin, the thermoplastic resin further comprises about 1 weight part to about 5 weight parts of a fluidity improver, and the fluidity improver includes a ring polyester.

20. The method according to claim 11, wherein the resin composition further comprises a filler including at least one of fiber filler and inorganic particles filler.

21. A stainless steel-resin composite prepared by claim 1, comprising:
a stainless steel substrate having a porous surface, and
a resin layer disposed on the porous surface of the stainless steel substrate.
